(19) United States
(12) Patent Application Publication
(10) Pub. No.: US 2026/0309607 A1
(43) Pub. Date: Oct. 8, 2026

(54) SYSTEM AND METHOD FOR MEASURING RHEOLOGICAL PROPERTIES OF FLUID BY USING ROTATING BODY HAVING ANY SHAPE

(71) Applicant: INDUSTRY-ACADEMIC COOPERATION FOUNDATION GYEONGSANG NATIONAL UNIVERSITY, Jinju-si, Gyeongsangnam-do (KR)

(72) Inventors: Wook Ryol HWANG, Jinju-si, Gyeongsangnam-do (KR); Hye Jin AHN, Busan (KR)

(73) Assignee: INDUSTRY-ACADEMIC COOPERATION FOUNDATION GYEONGSANG NATIONAL UNIVERSITY, Jinju-si, Gyeongsangnam-do (KR)

(21) Appl. No.: 19/478,643

(22) PCT Filed: Apr. 17, 2024
(86) PCT No.: PCT/KR2024/005125

§ 371 Date: Oct. 24, 2025

(30) Foreign Application Priority Data
Apr. 27, 2023 (KR) 10-2023-0055682
Jun. 19, 2023 (KR) 10-2023-0078029

(51) Int. Cl. G01N 11/14; G01N 11/00

(52) U.S. Cl. CPC G01N 11/14; G01N 2011/0026

(57) ABSTRACT

A system for measuring rheological properties of a fluid using a rotating body of an arbitrary shape, includes a container capable of containing a fluid, a rotating body that is arranged vertically from the ground and moves under preset conditions while inserted into the container in contact with the fluid, a measurement portion measuring motion information of the rotating body, and a monitoring module displaying rheological property information of the fluid on the basis of the motion information of the rotating body measured by the measuring portion. The monitoring module is capable of calculating rheological property information of the fluid regardless of shapes of the rotating body and the container.

### CROSS-REFERENCE TO PRIOR APPLICATIONS

This Application is a National Stage Patent Application of PCT International Application No. PCT/KR2024/005125 (filed on Apr. 17, 2024), which claims priority to Korean Patent Application Nos. 10-2023-0055682 (filed on Apr. 27, 2023) and 10-2023-0078029 (filed on Jun. 19, 2023), which are all hereby incorporated by reference in their entirety.

### BACKGROUND

The present invention relates to a system for measuring rheological properties of a fluid using a rotating body of an arbitrary shape and a method therefor, and more particularly, to a system for measuring rheological properties of a fluid using a rotating body of an arbitrary shape, which quantifies a flow based on energy dissipation rate and measures rheological properties of a complex fluid from rotational speed and torque information of the rotating body and a method therefor.

In industries such as polymer compounding, secondary batteries, and electronic materials, the flow and deformation experienced by materials during processing have a decisive impact on the quality and properties of the final product. For example, secondary battery materials are complex fluids composed of organic and inorganic substances, and they are molded and processed into products through complex flow and deformation processes. Furthermore, understanding the inherent rheological properties of complex fluids is essential to further improving the processing of products in various industries such as plastics, films, adhesives, textiles, and cosmetics.

A conventional technology has been disclosed for measuring such rheological properties by applying deformation or stress to a material using a rheometer, measuring the resulting stress or deformation, and predicting the inherent rheological properties. However, according to the conventional technology, measurement is only possible using a specific container of the rheometer, so there is a problem in that a material that has completed a process must be sampled for measurement.

As a prior art document for solving the above-described problem, Korean Patent Publication No. 10-2013036 discloses a method and a system for measuring viscosity in a continuous flow field as well as a method and a system for predicting the flow rate or pressure drop of a non-Newtonian fluid in a continuous flow field.

However, even this prior technology has difficulty in measuring the rheological properties of a material through a rotating body of an arbitrary shape and various types of containers.

### SUMMARY

The present invention has been devised to solve the above-described problem of the prior art, and an object of the present invention is to predict the rheological properties of a material through the torque and rotational speed applied to a rotating body of an arbitrary shape that rotates within a material contained in a container.

The present invention relates to a method for measuring rheological properties of a fluid using a rotating body of an arbitrary shape, and more specifically, a method for measuring rheological properties of a fluid using a rotating body of an arbitrary shape according to a preferred embodiment of the present invention includes: a shape coefficient derivation step of deriving a shape coefficient of the rotating body on the basis of the motion characteristics of the rotating body for a fluid of which rheological properties are known; a motion measurement step in which a measurement portion measures motion information of the rotating body moving under preset conditions while the rotating body is in contact with the fluid of which rheological properties are to be measured in a container; and a rheological property calculation step of calculating rheological property information of the fluid to be measured on the basis of the shape coefficient of the rotating body and the motion information of the rotating body.

By addressing the above-described problem, the present invention enables the measurement of linear and nonlinear viscoelastic data under oscillatory shear flow, which was previously considered the preserve of expensive, state-of-the-art rheometers, without the need for a rheometer.

In addition, by enabling the selection a variety of rotating body shapes and container shapes, the present invention has the advantage that problems such as end collapse, difficulty in sample loading, and high-shear regimes can all be resolved.

In addition, the present invention can be installed directly on site in industrial settings for process control of complex fluid processing and enable real-time monitoring of the rheological properties, including the viscoelastic behavior, of complex fluids during processing in situ.

### BRIEF DESCRIPTION OF THE DRAWINGS

FIGS. 1A-1D show schematic diagrams illustrating a container of a system for measuring rheological properties of a fluid using a rotating body of an arbitrary shape according to the present invention.

FIGS. 2A-2I show schematic diagrams illustrating an example in which a rotating body is provided in an arbitrary shape in a system for measuring rheological properties of a fluid using a rotating body of an arbitrary shape according to the present invention.

FIG. 3 shows a diagram illustrating the configuration of a measuring portion and a monitoring module of a system for measuring rheological properties of a fluid using a rotating body of an arbitrary shape according to the present invention.

FIGS. 4A-4D show schematic diagrams illustrating the shapes of containers of a system for measuring rheological properties of a fluid using a rotating body of an arbitrary shape according to the present invention, wherein FIG. 4A shows a standard-shaped parallel plate (PP) container, FIGS. 4B-4C show PP containers with improved shapes, and FIG. 4D shows a cone-and-plate (CP) container with an improved shape.

FIG. 5 shows a flowchart of a method for measuring rheological properties of a fluid using a rotating body of an arbitrary shape according to the present invention.

FIGS. 6A-6B show graphs comparing the phase angle measurement values and the storage modulus (G′) and loss modulus (G″) measurement results according to angular frequency for a CP fixture of a rheometer geometry and rotating bodies of arbitrary shapes (Disk, FBT4a, FBT4b, Anchor).

FIG. 7 shows a table showing the Kp and Ks values for the four rotating bodies shown in FIGS. 6A-6B.

FIGS. 8A-8B show graphs comparing the linear and nonlinear storage modulus (G′) and loss modulus (G″) prediction results for a CP fixture, which is a standard rheometer fixture, and rotating bodies of arbitrary shapes (Disk, FBT2, FBT3, Anchor).

FIGS. 9A-9B show graphs illustrating the correlation between viscosity and shear rate according to the correction of a PP container for a polymer solution.

FIGS. 10A-10B show graphs comparing the nonlinear storage modulus and loss modulus measurements of a CP fixture and a PP fixture, which are standard rheometer fixtures.

### DETAILED DESCRIPTION

The terms used herein will be briefly explained, and then the present invention will be described in detail.

The terms used herein are selected as general terms that are currently widely used as much as possible while considering the functions in the present invention, but they may vary depending on the intention of those of ordinary skill in the art, precedents, the emergence of new technology, or the like. Therefore, the terms used in the present invention should be defined based on the meaning of the terms and the overall content of the present invention, rather than simply the names of the terms.

Throughout the present specification, when a part is said to “comprise” a certain element, unless otherwise specified, it means that other elements may be further included rather than excluding other elements.

Hereinafter, with reference to the attached drawings, embodiments of the present invention are described in detail so that those skilled in the art may easily implement the present invention. However, the present invention may be implemented in various different forms and is not limited to the embodiments described herein.

The specific details of the present invention, including the problems to be solved, the means for solving the problems, and the effects of the invention, are included in the embodiments and drawings described below. The advantages and features of the present invention as well as the methods for achieving them will become clearer with reference to the embodiments described in detail below together with the accompanying drawings.

In addition, before explaining the present invention, it should be noted that the flow and deformation that a material experiences during the process of manufacturing a product have a decisive impact on the quality and characteristics of the final product, and the unique properties that a material exhibits during the process of flow and deformation are the representative rheological properties of the material. In this case, secondary battery materials, which have recently attracted increasing industrial interest together with plastics, films, adhesives, fibers, and cosmetics, are complex fluids with a very complex structure consisting of a mixture of organic and inorganic substances, and are molded and processed into products through a complex form of flow and deformation process. Therefore, understanding the unique rheological properties of the material is essential in the processing. The method for measuring such rheological properties utilizes a rheometer, which is a highly accurate device for measuring rheological properties by implementing various types of flow fields, to apply deformation or stress to the material and measure the resulting stress or strain to obtain the material's unique rheological function (rheological properties). Among various types of flow, the most commonly used experiment to measure the inherent viscoelastic properties of a material is to measure the dynamic oscillatory shear flow. Unlike steady shear flow, which is applied in one direction, this method applies oscillatory shear deformation with a sinusoidal periodicity in both directions while fixing the angular frequency or strain amplitude and measures the resulting stress change as a function of frequency (ω) or amplitude (γ₀) as a rheological property. There are many other experimental methods, which will be described later. In addition, when oscillatory shear deformation is applied, a material with viscoelasticity accumulates deformation energy as stress inside the material, which is exhibited as storage modulus (G′) representing the elasticity of the material, and loses the energy given to the material through energy dissipation, which is exhibited as loss modulus (G″) representing the viscosity of the material. In particular, in the industrial field that uses various polymer composites, including secondary batteries, there are various processes such as mixing, coating, and printing, so the change in the physical properties of materials according to each process condition is a very sensitive issue. From this point of view, when the in real-time (linear and nonlinear) viscoelastic rheological properties of the composite fluid can be monitored, it can be of great help in actual process analysis and optimization. However, in the conventional theory, since measurement is only possible using a specific container of the rheometer (cone-and-plate: CP, parallel plate: PP), the material has to be sampled and measured after the process is completed. Moreover, rheometers are too expensive to provide to all industrial sites, and there are significant restrictions on the equipment size and installation location. Since in-situ measurement is impossible, rheometers are not suitable equipment for real-time viscoelastic monitoring required in various processes. The present invention is a technique that obtains the effective energy dissipation rate coefficient and the effective shear rate coefficient based on the rotational speed and measured torque information (magnitude, phase difference) of a flow of a rotating body of an arbitrary shape using a flow quantification method based on energy dissipation rate and predicts the storage modulus and loss modulus of a material very accurately based on the obtained effective energy dissipation rate coefficient and the effective shear rate coefficient. The present invention was devised to enable direct installation (on-site) of the system in an actual industrial process for process control and in situ real-time monitoring of the viscoelastic behavior of a fluid during the process.

Hereinafter, a system for measuring rheological properties of a fluid using a rotating body of an arbitrary shape according to the present invention will be described.

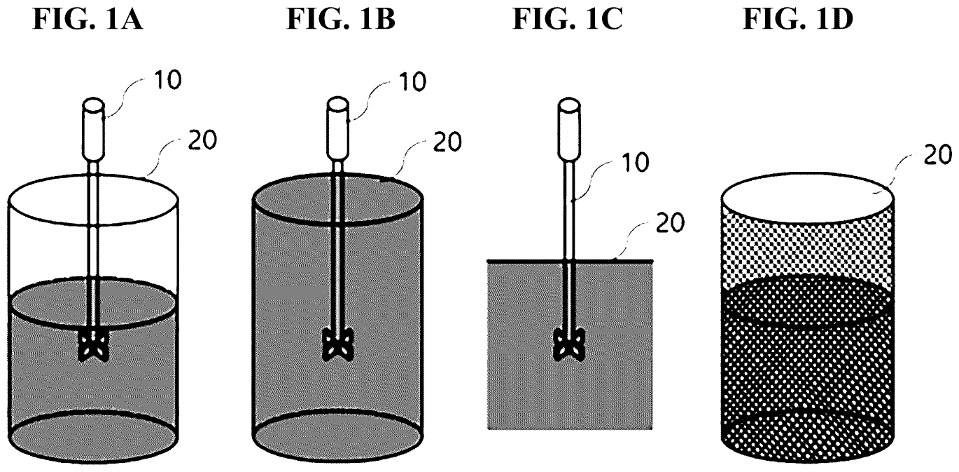

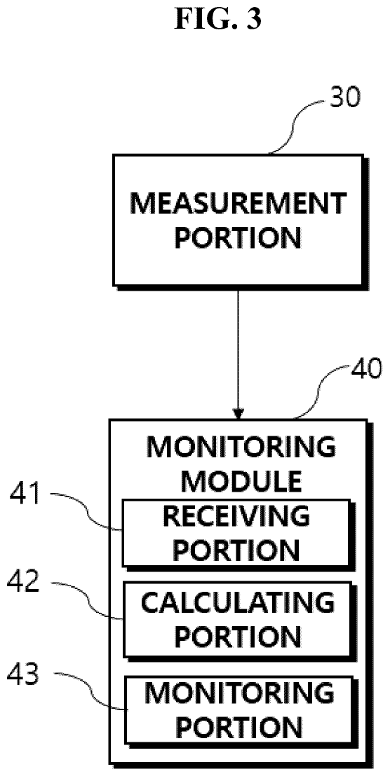

Referring to FIGS. 1A-1D, 2A-2I, and 3, the present invention includes: a container 20 capable of containing a fluid, a rotating body 10 that is arranged vertically from the ground and moves under preset conditions while inserted into the container 20 in contact with the fluid, a measurement portion 30 measuring motion information of the rotating body 10; and a monitoring module 40 that inputs the motion information measured from the measurement portion 30 into the following Mathematical Formula 9 so that rheological property information of the fluid may be displayed. In addition, the monitoring module 40 monitors rheological property behavior of the fluid in real time during an industrial process. In addition, the monitoring module 40 may calculate rheological property information of the fluid based on the motion information of the rotating body 10 measured based on the measurement portion 30, regardless of the shapes of the rotating body 10 and the container.

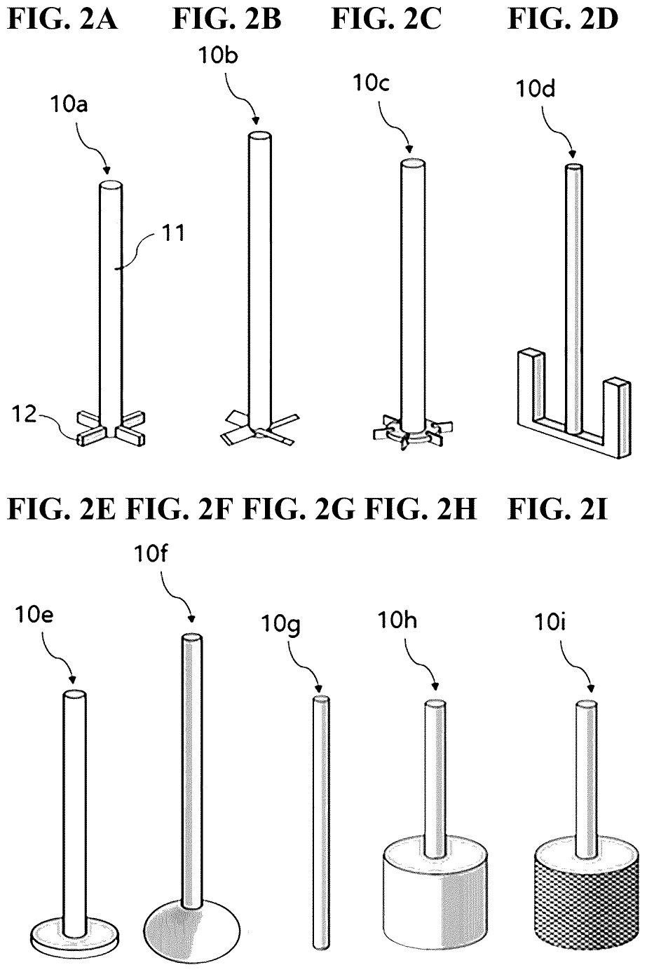

First, referring to FIGS. 1A-1D and 2A-2I, as the main components of the system for measuring rheological properties of a fluid in the present invention, a container 20 accommodating a fluid and a rotating body 10 rotating within the container 20 are provided. In order to measure the inherent rheological property information of the fluid within the container 20, a dynamic oscillatory shear experiment is performed. Unlike a steady-state shear flow applied in one direction, this is a method of applying an oscillatory shear strain having a sinusoidal periodicity in both directions while fixing the angular frequency or strain amplitude and calculating and measuring the rheological property information according to the resulting stress change as a function of the frequency or amplitude. At this time, when oscillatory shear deformation is applied to the fluid, a fluid with viscoelasticity accumulates deformation energy as stress inside the material, which is exhibited as storage modulus (G′) representing the elasticity of the material, and loses the energy given to the material through energy dissipation, which is exhibited as loss modulus (G″) representing the viscosity of the material. In other words, the present invention calculates the effective energy dissipation rate coefficient and the effective shear rate coefficient based on the rotational speed and torque information in the flow caused by the rotating body 10 through an energy dissipation rate-based quantification technique and calculates the storage modulus and the loss modulus. At this time, the experimental method for measuring the rheological property information of the flow field in the system according to the present invention may be performed in various experimental methods other than dynamic oscillatory shear. For example, the experimental method includes a shear flow viscosity measurement experiment, a start-up shear flow experiment, a stress relaxation experiment, a creep experiment, a linear relaxation experiment, a linear viscoelasticity measurement experiment, and a nonlinear viscoelasticity measurement experiment. However, the present invention will be described based on the flow by the dynamic oscillatory shear.

In addition, the theory of linear viscoelasticity measurement will be explained. The dynamic oscillatory shear flow by the rotating body 10 applies a deformation with a sinusoidal periodicity to the container 20, and the change in stress according to this may be expressed as a function of frequency as in the following Mathematical Formula 1. The measured stress reflects the phase difference due to the inherent viscoelastic properties of the material, and this is known as an intermediate form between an elastic body and a viscous body.

$$γ = {γ}_{0} sin ( ω t ) , τ = {τ}_{0} sin ( ω t + δ ) \qquad [ Mathematical Formula 1 ]$$

Here, γ is strain, γ₀ is strain amplitude, ω is angular frequency, τ is shear stress, τ₀ is shear stress amplitude, t is time, and δ is phase difference.

In addition, the measured stress is divided into the storage modulus G′ representing the elasticity of the fluid and the loss modulus G″ representing the viscosity, and may be expressed as in the following Mathematical Formulas 2a and 2b.

$$τ = {τ}_{0} cos δ sin ( ω t ) + {τ}_{0} sin δ cos ( ω t ) = {γ}_{0} {G}^{′} sin ( ω t ) + {γ}_{0} {G}^{″} cos ( ω t ) \qquad [ Mathematical Formula 2 a ]$$

$${G}^{′} ( ω ) ≡ \frac{{τ}_{0}}{{γ}_{0}} cos δ , {G}^{″} ( ω ) ≡ \frac{{τ}_{0}}{{γ}_{0}} sin δ \qquad [ Mathematical Formula 2 b ]$$

In addition, the rotating body 10 performs a dynamic oscillation motion at a preset rotation angle and frequency so that the rheological properties of the fluid may be measured within the system according to the present invention. In particular, the rotating body 10 is vertically inserted into the container 20 and is formed to be point-symmetrical with respect to a rotational axis 11 so that no bending moment is applied to the rotational axis 11. For example, the rotating body 10 includes a paddle 12 provided at an end of the rotating body 10, and the paddle 12 is provided to be point-symmetrical with respect to a cross-section with respect to the axial direction of the rotating body 10 so that no bending moment is applied to the axis of the rotating body 10 when stationary, and a drag force due to the fluid may be applied uniformly even when rotating. For example, as shown in FIGS. 2A-2I, the rotating body 10 may be provided in various forms, and one of them may be selectively provided. The paddle 12a illustrated in FIG. 2A is formed to protrude in four directions in a cross shape. The paddle 12b illustrated in FIG. 2B is formed to have a pitch, and each side surface of the paddle 12b protruding in four directions is formed to have a twist angle with respect to each other. The paddle 12c illustrated in FIG. 2C has the form of a Rushton turbine with a plurality of paddles 12c extending from the external circumference of a circular plate. The paddle 12d illustrated in FIG. 2D is formed in an anchor shape similar to the Chinese character ‘\hat{ }’ (literally meaning ‘mountain’). The paddle 12e illustrated in FIG. 2E has a circular plate form and provided in a disk shape arranged to be perpendicular to the rotational axis 11. The paddle 12f illustrated in FIG. 2F is formed in the form of a sphere that is installed at an end of the rotational axis 11. The paddle 12g illustrated in FIG. 2G is provided in a needle form. The paddle 12h illustrated in of FIG. 2H is provided in a cylinder shape having a diameter larger than that of the rotational axis 11. The paddle 12i illustrated in FIG. 2I is formed so that a pattern is provided on the external circumference of the cylinder having a diameter larger than that of the rotational axis 11, thereby preventing a slip from occurring on the inner wall surface of the container 20. In this way, any one of the various shapes of the paddle 12 illustrated in FIGS. 2A-2I may be selected, and within the scope of the embodiment of the present invention, a rotating body 10 of any shape may be used when an accurate torque measurement value may be obtained. In other words, a rotating body 10 of any shape may be used as long as the mass is symmetrically distributed so that no bending moment is applied to the axis even when the rotating body 10 is in a static state, and the mass moment of inertia of the rotating body 10 and the drag force of the fluid applied to the wall surface (blade, etc.) of the rotating body are symmetrically distributed so that the axis does not vibrate even when the rotating body 10 is in a rotating state. Of course, when the magnitude of the bending moment in the static state or the mass moment of inertia/drag force in the rotating state is small so that it has little effect on the accuracy of the torque measurement of the rotating body 10, an asymmetric rotating body 10 may also be used.

The container 20 is provided so that the fluid to be measured for rheological properties may be accommodated therein. At this time, referring to FIGS. 1A-D, the container 20 may be provided in various shapes, such as a shape with a gas-liquid boundary as in FIG. 1A, a shape in which the fluid is completely confined to the wall and is closed as in FIG. 1B, a shape in which the side wall is open as in as in FIG. 1C, and a shape in which a pattern is provided on the inner surface of the container 20 as in FIG. 1D. At this time, the container 20 provided in the shape illustrated in FIG. 1A may prevent wall fracture when measuring the rheological properties of the fluid. In addition, the container 20 provided in the shape illustrated in FIG. 1B may prevent the effect of a free surface when measuring the rheological properties of the fluid. In addition, the container 20 provided in the shape illustrated FIG. 1C may exclude the shape effect of the container 20 when the container 20 is much larger than the size of the rotating body 10 when measuring the rheological property information of the fluid. In addition, the container 20 provided in the shape illustrated FIG. 1D may prevent a slip from occurring on the wall surface due to a particle suspension having a high particle fraction or a polymer fluid having a high molecular weight when measuring the rheological property information of the fluid. In addition, the container 20 has a pattern provided on the wall surface to prevent a wall slip, or enables the measurement of rheological property information even in a non-cylindrical container.

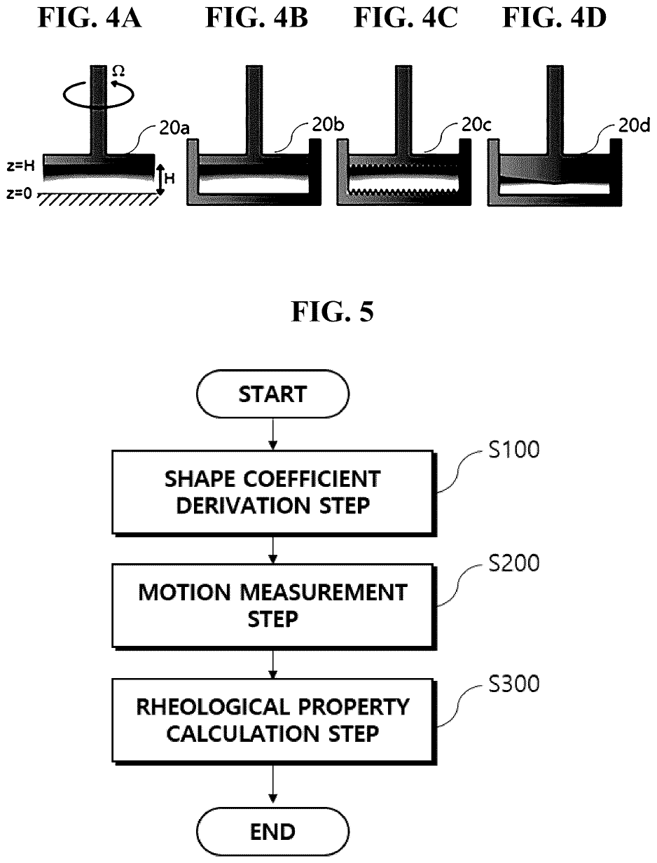

In addition, referring to FIGS. 4A-4D, the container 20 may be provided in a parallel plate (PP) fixture shape. As illustrated in FIG. 4A, the container 20a may be provided in a standard PP fixture shape without a side wall. In this case, the container 20 may be improved to a functional shape. For example, as illustrated in FIG. 4B, the container 20b may be provided in a PP shape with a side wall surface wrapped. The container 20b may prevent the end collapse when measuring rheological information. In addition, as illustrated in FIG. 4C, the container 20c may be provided in a PP shape with a wall surface of which pattern is wrapped. The container 20c may be provided with patterns on all inner surfaces and may be used to measure rheological information of a fluid prepared as a high molecular weight polymer and a high particle fraction suspension. In addition, as shown in FIG. 4D, the container 20d may be provided in a cone-and-plate (CP) shape with the wall surface wrapped. The container 20d allows the process of loading the fluid inside to be conducted easily. In this way, in the present invention, the rotating body 10 and the container 20 may be provided in various shapes, and the measurement of the rheological properties of the fluid is possible in any shapes.

The measurement portion 30 measures the motion information of the rotating body 10. For example, the measurement portion 30 measures the rotation angle and rotation period of the rotating body 10 in the form of angular frequency. In addition, the measurement portion 30 measures the torque applied as a drag force by the fluid during the rotation of the rotating body 10.

The monitoring module 40 includes a receiving portion 41 that receives the motion information measured from the measurement portion 30, a calculating portion 42 that calculates the rheological property information of the fluid using the motion information received from the receiving portion 41, and a monitoring portion 43 that displays the result value calculated from the calculating portion 42 to the user. At this time, the calculating portion 42 calculates the storage elastic modulus and the loss elastic modulus of the fluid through the Mathematical Formulas 9, 19a, and 19b below, so that the viscoelasticity of the fluid may be measured in a linear region and a nonlinear region.

$${G}^{′} ( ω ) = {ωη}^{″} ( ω ) = \frac{1}{α} \frac{{M}_{0}}{{θ}_{0}} cos δ , \qquad [ Mathematical Formula 9 ]$$

$${G}^{″} ( ω ) = {ωη}^{′} ( ω ) = \frac{1}{α} \frac{{M}_{0}}{{θ}_{0}} sin δ$$

$${G}^{′} ( ω ) = Re \{ \frac{{\overline{τ}}^{*}}{{\overline{γ}}^{*}} \} = \frac{{α}_{τ}}{{α}_{γ}} \frac{{M}_{0}}{{θ}_{0}} Re \{ {e}^{i δ} \} = \frac{{π}^{2}}{2 {K}_{p} {R}^{3}} \frac{{M}_{0}}{{θ}_{0}} cos δ \qquad [ Mathematical Formula 19 a ]$$

$${G}^{″} ( ω ) = Im \{ \frac{{\overline{τ}}^{*}}{{\overline{γ}}^{*}} \} = \frac{{α}_{τ}}{{α}_{γ}} \frac{{M}_{0}}{{θ}_{0}} Im \{ {e}^{i δ} \} = \frac{{π}^{2}}{2 {K}_{p} {R}^{3}} \frac{{M}_{0}}{{θ}_{0}} sin δ \qquad [ Mathematical Formula 19 b ]$$

In addition, the calculating portion 42 calculates the shape coefficient of the rotating body 10 through the following Mathematical Formula 12, so that the rheological property information of the fluid may be measured even when the rotating body 10 is prepared in various shapes, as shown in FIGS. 2A-2I.

$$M = \frac{2 {R}^{3}}{{π}^{2}} {K}_{p} \cdot η Ω = αη Ω , α = \frac{2 {R}^{3}}{{π}^{2}} {K}_{p} \qquad [ Mathematical Formula 12 ]$$

Hereinafter, a method for measuring rheological properties of a fluid using a rotating body of an arbitrary shape using a rheological property measuring system of a fluid according to the present invention will be described.

Referring to FIG. 5, the method includes: a shape coefficient derivation step S100 of deriving a shape coefficient of the rotating body 10 on the basis of the motion characteristics of the rotating body 10 for a fluid of which rheological properties are known; a motion measurement step S200 in which a measurement portion 30 measures motion information of the rotating body 10 moving under preset conditions while the rotating body is in contact with the fluid of which rheological properties are to be measured in a container 20; and a rheological property calculation step S300 of calculating rheological property information of the fluid to be measured on the basis of the shape coefficient of the rotating body 10 and the motion information of the rotating body 10. In the present invention, a dynamic oscillatory shear experiment is performed to measure the inherent viscoelastic properties of the fluid in the container 20. In addition, unlike the steady-state shear flow applied in one direction, oscillatory shear deformation with a sinusoidal periodicity is applied in both directions while fixing the angular frequency or strain amplitude, and the resulting stress change is measured as a rheological property as a function of frequency or amplitude.

In other words, the motion characteristics include at least one of the torque applied to the rotating body 10, the phase difference, the angular frequency, and the rotational speed. Furthermore, the preset condition refers to either the angular frequency or the amplitude. At this time, the experiment for measuring the rheological properties of the flow field in the system according to the present invention may be performed using various experimental methods other than dynamic oscillatory shear. For example, the experimental method includes a shear flow viscosity measurement experiment, a start-up shear flow experiment, a stress relaxation experiment, a creep experiment, a linear relaxation experiment, a linear viscoelasticity measurement experiment, and a nonlinear viscoelasticity measurement experiment. However, the present invention will be described based on the flow by the dynamic oscillatory shear.

First, the theory of linear viscoelasticity measurement will be explained. The dynamic oscillatory shear flow by the rotating body 10 applies a deformation with a sinusoidal periodicity to the container 20, and the change in stress according to this may be expressed as a function of frequency as in the following Mathematical Formula 1. The measured stress reflects the phase difference due to the inherent viscoelastic properties of the material, and this is known as an intermediate form between an elastic body and a viscous body.

$$γ = {γ}_{0} sin ( ω t ) , τ = {τ}_{0} sin ( ω t + δ ) \qquad [ Mathematical Formula 1 ]$$

Here, γ is strain, γ₀ is strain amplitude, ω is angular frequency, τ is shear stress, τ₀ is shear stress amplitude, t is time, and δ is phase difference.

In addition, the measured stress is divided into the storage modulus G′ representing the elasticity of the fluid and the loss modulus G″ representing the viscosity, and may be expressed as in the following Mathematical Formulas 2a and 2b.

$$τ = {τ}_{0} cos δ sin ( ω t ) + {τ}_{0} sin δ cos ( ω t ) = {γ}_{0} {G}^{′} sin ( ω t ) + {γ}_{0} {G}^{″} cos ( ω t ) \qquad [ Mathematical Formula 2 a ]$$

$${G}^{′} ( ω ) ≡ \frac{{τ}_{0}}{{γ}_{0}} cos δ , {G}^{″} ( ω ) ≡ \frac{{τ}_{0}}{{γ}_{0}} sin δ \qquad [ Mathematical Formula 2 b ]$$

In other words, the present invention presents a technique for measuring linear viscoelasticity and nonlinear viscoelasticity of a fluid by using dynamic oscillatory shear about a rotational axis, when a rotating body 10 of a general shape is immersed in a fluid of which rheological properties are to be measured and by using the torque at the rotational axis and the amplitude of dynamic oscillatory shear and the frequency of dynamic oscillatory shear. At this time, the container 20 accommodating the fluid therein may be provided in various shapes. For example, a gas-liquid boundary may be formed as shown in FIG. 1A, the fluid may be completely surrounded by the container 20 as shown in FIG. 1B, and the rheological properties of the fluid may be measured even when the container 20 has no wall surface as shown in FIG. 1C. In addition, in the present invention, the rheological properties of the fluid may be measured even when there is a pattern on the wall surface of the container 20 as shown in FIG. 1D. In other words, in the present invention, the case where the rotating body 10 is contained in the container 20 is described as an example as an embodiment of the present invention, but the rheological properties of the fluid may be measured through containers 20 of various shapes, as shown in FIGS. 1A-1D. The various shapes of containers 20 illustrated in FIGS. 1A-1D will be described in more detail. The shape of FIG. 1A may prevent edge fracture during viscoelasticity measurement, the shape of FIG. 1B may prevent the effect of the free surface in the measurement, FIG. 1C shows that the shape effect of the container may be excluded when the container is much larger than the size of the rotating body, and FIG. 1D shows that the present theory may be commonly applied even when a pattern is provided on the wall to avoid a slip that may occur in the case of a particle suspension with a high particle fraction or a polymer fluid with a high molecular weight. In addition, the theory may be commonly applied to containers that are not cylindrical. A rotating body 10 of any shape may be used as long as the mass is symmetrically distributed so that no bending moment is applied to the axis even in a static state, and an accurate torque measurement value may be obtained. At this time, when the magnitude of the bending moment in the static state or the mass moment of inertia/drag force in the rotating state is small so that it has little effect on the accuracy of the torque measurement of the rotating body 10, an asymmetric rotating body 10 may also be used.

In addition, when a rotating body rotates at an angular velocity Ω [rad/s] in a fluid having a viscosity of η, the torque M of the rotating axis is proportional to the product of the viscosity and the angular velocity. In other words, M∝ηΩ, and it may be expressed as in Mathematical Formula 3 below. When the proportionality constant of this relationship is α, then α is a value determined by the shape of the rotating body 10, the shape of the container containing the fluid, and the height of the fluid.

$$M ∝ ηΩ \qquad [ Mathematical Formula 3 ]$$

Here, there may be various methods for obtaining the shape coefficient α. For a Newtonian fluid of which viscosity is experimentally known, the shape coefficient α may be easily obtained by measuring the torque with respect to the angular velocity of a rotating body 10, and the shape coefficient may also be obtained using a numerical analysis method in the same manner. It is obvious that one of ordinary skill in the field of fluid mechanics may obtain the shape coefficient without any particular technical difficulties.

In addition, the measurement method according to the present invention utilizes the energy dissipation rate-based flow quantification technique developed by Metzner and Otto. This flow quantification technique may clearly express the correlation between torque and shear stress, as well as the correlation between the rotation angle and shear rate, which are characteristic values necessary for obtaining not only linear viscoelasticity but also nonlinear viscoelasticity. In addition, the technique may serve as a theoretical basis for measuring the rheological properties of a nonlinear fluid.

First, the method for measuring rheological properties using the shape coefficient derived from Mathematical Formula 3 will be explained, and then the measurement of rheological properties of nonlinear fluids using the expression of the shape coefficient using the technique of Metzner and Otto will be described. When the fluid to be measured is a non-Newtonian fluid, the shape coefficient of the rotating body 10 may be calculated from the proportional constant of the dimensionless Power number Nₚ and the Reynolds number Re.

When a deflection angle θ(t)=θ₀ cos(ωt) is applied to the axis of the rotating body 10 immersed in the fluid as a periodic oscillation, the angular frequency becomes ω(t)=−θ₀ω sin(ωt). At this time, when θ₀ is sufficiently small, the torque measured on the axis of the rotating body 10 has a phase difference δ and is expressed as in Mathematical Formula 4 below.

$$M ( t ) = {M}_{0} cos ( ω t + δ ) , \qquad [ Mathematical Formula 4 ]$$

$$θ ( t ) = {θ}_{0} cos ( ω t ) , ω ( t ) = - {θ}_{0} ωsin ( ω t )$$

At this time, the correlation between the torque M₀ and frequency ωₙ(=θ₀ω) follows Mathematical Formula 1 above. In other words, the viscosity may be expressed as a complex viscosity η* and may be expressed as in Mathematical Formula 5 below.

$$M ( t ) = {M}_{0} cos ( ω t + δ ) = - {θ}_{0} ω sin ( ω t ) {αη}^{*} ω ( t ) \qquad [ Mathematical Formula 5 ]$$

When the amplitude of the rotation angle θ₀ of the axis in Mathematical Formula 5 is sufficiently small, the complex viscosity η* becomes a function of frequency only, and the complex viscosity may be expressed using torque behavior. At this time, for the convenience of calculation, a complex number expression as in Mathematical Formula 6 below is introduced, and the complex number expression of the complex viscosity may be expressed as in Mathematical Formula 7 below.

$$θ ( t ) , R e \{ {θ}_{0} {e}^{i ω t} \} , ω ( t ) = R e \{ i {θ}_{0} ω {e}^{i ω t} \} , \qquad [ Mathematical Formula 6 ]$$

$$M ( t ) = R e \{ {M}_{0} e \text{?} \}$$

$$η \text{?} ( ω ) = η \text{?} - i η \text{?} = \frac{1}{\text{?}} \frac{{M}_{0}}{{θ}_{0} ω} ( sin δ - i cos δ ) \qquad [ Mathematical Formula 7 ]$$

$$\text{?} \text{indicates text missing or illegible when filed}$$

By using the complex viscosity expressed in Mathematical Formula 7 and the general correlation between the complex viscosity and the complex modulus in the linear viscoelasticity of Mathematical Formula 8 below, the storage modulus G′ and the loss modulus G″ may be calculated as in Mathematical Formula 9 below. At this time, the above G′ and G″ are functions of frequency ω only, because the amplitude of the rotation angle of the axis is sufficiently small.

$${G}^{′} = ω {η}^{″} , G \text{?} = {ωη}^{′} \qquad [ Mathematical Formula 8 ]$$

$${G}^{′} ( ω ) = ωη \text{?} ( ω ) = \frac{1}{α} \frac{{M}_{0}}{{θ}_{0}} cos δ , \qquad [ Mathematical Formula 9 ]$$

$${G}^{″} ( ω ) = {ωη}^{′} ( ω ) = \frac{1}{α} \frac{{M}_{0}}{{θ}_{0}} sin δ$$

$$\text{?} \text{indicates text missing or illegible when filed}$$

The Mathematical Formula 9 may be used as a mathematical formula for calculating the viscoelasticity of a fluid by using the rotational oscillation of a rotating axis contained in the fluid.

Hereinafter, the measurement of nonlinear viscoelasticity will be described. When determining the storage modulus G′ and the loss modulus G″, the case where the amplitude of the rotation angle is large is referred to as a nonlinear region. At this time, the storage modulus G′ and the loss modulus G″ become functions of both the amplitude of the rotation angle and the frequency, and this is defined as nonlinear viscoelasticity. In order to obtain the nonlinear viscoelasticity, the correlations between the torque measured in a general rotating body and the representative shear stress of the system and between the amplitude of the rotation angle of the rotating body axis and the representative shear strain of the system are obtained, and the representative shear stress and the representative shear strain may be substituted into Mathematical Formula 2B to obtain the storage modulus and the loss modulus. At this time, the linear viscoelasticity prediction technique of Mathematical Formula 9 may also be directly applied to the nonlinear viscoelasticity prediction technique.

In the present invention, in order to obtain a representative shear stress and a representative shear rate in the flow by the rotating body 10, an energy dissipation rate-based flow quantification in an agitator flow is introduced so that the shape coefficient α through Mathematical Formula 3 may be more accurately calculated. In addition, the energy dissipation rate-based flow quantification is a method of obtaining a characteristic curve of the rotating body 10 flow using dimensionless Power number Nₚ and Reynolds number Re, and a characteristic curve may be determined for the shape of the rheological property measurement system (shape of rotating body 10, shape of container 20, fluid height, etc.).

When a rotating body 10 rotates at an angular velocity Ω [rad/s] in a fluid with a viscosity η and the torque on the rotating axis is M, the power P applied to the system is calculated as P-MΩ. This characteristic value is equal to the sum of the energy dissipation rates within the system in the laminar flow region. p=∫_{V}η\dot{γ}²dV. (Here, the power is the net power excluding power loss due to friction at the seal or reducer from the motor power, and is referred to as the total energy dissipation rate in the present invention.)

Furthermore, the power number Nₚ is a value calculated by dividing the total energy dissipation rate by the characteristic energy dissipation rate in the turbulent flow region. For the rotating body 10, this value is expressed using the rotational speed N [rps] (Ω=2πN) and the diameter D of the rotating body 10 (D=2R). Furthermore, the Reynolds number Re of the rotating body 10, where the fluid density is ρ, may be expressed as in Mathematical Formula 10 below due to these variables.

$${N}_{p} = \frac{2 π NM}{ρ {N}^{3} {D}^{5}} = \frac{{π}^{3} M}{4 {ρΩ}^{2} {R}^{5}} , \qquad [ Mathematical Formula 10 ]$$

$$R e = \frac{ρ {ND}^{2}}{η} = \frac{2 ρΩ {R}^{2}}{πη}$$

In addition, in the laminar flow region of a Newtonian fluid with a constant viscosity, the Power number Nₚ is proportional to the inverse of the Reynolds number Re. In other words, Nₚ~Re⁻¹. When the proportionality constant is defined as Kp, the correlation between the Power number and the Reynolds number may be expressed as in Mathematical Formula 11 below.

$${N}_{p} ∼ R {e}^{- K p} . \qquad [ Mathematical Formula 11 ]$$

In Mathematical Formula 11, the proportionality constant Kp may be determined by the shape of the rotating body 10 system. In addition, when the definitions of the Power number and the Reynolds number defined in Mathematical Formula 10 are substituted into Mathematical Formula 11, the shape coefficient α of the rotating body 10 may be expressed as a mathematical formula using Kp as in Mathematical Formula 12 below. This is another method of obtaining the shape coefficient of the rotating body 10 described above.

$$M = \frac{2 {R}^{3}}{{π}^{2}} {K}_{p} \cdot ηΩ = αηΩ , α = \frac{2 {R}^{3}}{{π}^{2}} {K}_{p} \qquad [ Mathematical Formula 12 ]$$

Hereinafter, a method for obtaining the representative shear stress and representative shear rate of the rotating body 10 system will be described. More specifically, the rheological property calculation step S300 calculates the representative shear rate through Mathematical Formula 14 below, the representative shear strain through Mathematical Formula 15, and the representative shear stress through Mathematical Formula 17.

First, the representative shear stress τ̅ of the rotating body 10 is proportional to the torque M, and the representative shear rate γ̅₀ is proportional to the twist angle θ₀ of the axis, so by introducing the proportional constants α_{τ} and α_{γ}, respectively, they may be expressed as in Mathematical Formula 13 below.

$$τ = {α}_{τ} M and {\text{?}}_{0} = α \text{?} {θ}_{0} \qquad [ Mathematical Formula 13 ]$$

$$\text{?} \text{indicates text missing or illegible when filed}$$

According to the theory of Metzner and Otto, for the steady-state rotation of a rotating body 10 system, the rotational angular velocity Ω and the representative shear rate \overline{\dot{γ}} are determined to be proportional to the rotational angular velocity through the Metzner-Otto constant Ks (MO constant).

$$\text{?} = K \text{?} N = \frac{K \text{?}}{2 π} Ω \qquad [ Mathematical Formula 14 ]$$

$$\text{?} \text{indicates text missing or illegible when filed}$$

The correlation shown in Mathematical Formula 14 is a geometric relationship and may be applied in the same manner to a rotating body 10 that oscillates at a frequency ω. In addition, since the strain is obtained by integrating the shear rate over time, the magnitude of the strain may be used as a function of the twist angle of the axis, as in Mathematical Formula 15 below. In addition, the proportionality constant of the representative shear rate α_{γ} may be calculated through this.

$${\text{?}}_{0} = \frac{K \text{?}}{2 π} {θ}_{0} = α \text{?} {θ}_{0} α \text{?} = \frac{\text{?}}{2 π} \qquad Mathematical Formula 15$$

$$\text{?} \text{indicates text missing or illegible when filed}$$

Additionally, the shear rate \dot{γ}₀ of the oscillating axis may be expressed as α_{γ}θ₀ω.

Hereinafter, a method for obtaining the representative shear stress τ̅ from the torque M is described. First, the representative shear stress in the material is calculated by multiplying the representative shear rate determined from Mathematical Formula 14 by the average viscosity obtained using the Metzner-Otto theory. Here, it can be seen that the correlation between the representative shear stress and the representative shear rate is consistent with the relationship between the shear stress and the shear rate of the material. In other words, the representative stress τ̅ of the rotating body 10 system is the product of the representative shear rate \dot{γ̅} and the representative viscosity, which shows the relationship of τ=η(Ω)/(Ω) at the steady-state rotational angular velocity Ω. Here, the representative viscosity may be expressed by Mathematical Formula 16 below by substituting the definitions of the Power number and the Reynolds number defined in Mathematical Formula 10 into Mathematical Formula 11.

$$η ( Ω ) = \frac{{π}^{2}}{2 {R}^{3}} \frac{1}{{K}_{p}} \cdot \frac{M}{Ω} \qquad [ Mathematical Formula 16 ]$$

Therefore, by substituting the representative shear strain in Mathematical Formula 14 and the representative viscosity in Mathematical Formula 16, the representative shear stress may be expressed as a function of torque as in Mathematical Formula 17 below.

$$\overline{τ} = η {γ}^{\overline{.}} = \frac{π}{4 {R}^{3}} \frac{{K}_{s}}{{K}_{p}} \cdot M = {α}_{τ} M , {α}_{τ} = \frac{π}{4 {R}^{3}} \frac{{K}_{s}}{{K}_{p}} \qquad [ Mathematical Formula 17 ]$$

Using the representative shear stress τ̅ of Mathematical Formula 17 and the representative shear strain γ̅₀ of Mathematical Formula 15, the storage elastic modulus G′ and the loss elastic modulus G″ may be calculated using the method used in Mathematical Formulas 1 and 2. At this time, since the assumption of linear viscoelasticity is not necessary, it may be a general relationship that may be applied even to nonlinear viscoelasticity with a large rotation angle. In addition, for the purpose of formulating, the relationship for the complex shear rate γ̅* and complex shear stress τ* may be expressed as in Mathematical Formula 18 below.

$$\text{?} = {\text{?}}_{0} R e \{ {e}^{i ω t} \} = α \text{?} {θ}_{0} R e \{ {e}^{i ω t} \} , \qquad [ Mathematical Formula 18 ]$$

$$τ \text{?} = τ {\text{?}}_{0} R e \{ e \text{?} \} = α \text{?} {M}_{0} R e \{ e \text{?} \}$$

$$\text{?} \text{indicates text missing or illegible when filed}$$

In addition, through Mathematical Formulas 19a and 19b below, the storage elastic modulus G′ and the loss elastic modulus G″ may be calculated not only in the linear region but also in the nonlinear region.

$${G}^{′} ( ω ) = Re \{ \frac{τ \text{?}}{γ \text{?}} \} = \frac{{\text{?}}_{τ}}{{\text{?}}_{r}} \frac{{M}_{0}}{{θ}_{0}} Re \{ {e}^{i δ} \} = \frac{{π}^{2}}{2 {K}_{p} {R}^{3}} \frac{{M}_{0}}{{θ}_{0}} cos δ \qquad [ Mathematical Formula 19 a ]$$

$${G}^{″} ( ω ) = Im \{ \frac{τ \text{?}}{γ \text{?}} \} = \frac{{\text{?}}_{τ}}{{\text{?}}_{r}} \frac{{M}_{0}}{{θ}_{0}} Im \{ {e}^{i δ} \} = \frac{{π}^{2}}{2 {K}_{p} {R}^{3}} \frac{{M}_{0}}{{θ}_{0}} sin δ \qquad [ Mathematical Formula 19 b ]$$

$$\text{?} \text{indicates text missing or illegible when filed}$$

In addition, the relationship between the storage modulus G′ and the loss modulus G″ shown in Mathematical Formulas 19a and 19b is consistent with the mathematical formula for the storage modulus G′ and the loss modulus G″ in linear viscoelasticity of Mathematical Formula 9. In other words, the Mathematical Formula 9 may be used to calculate the viscoelasticity not only in the linear region but also in the nonlinear region.

Hereinafter, the method of correcting the representative shear rate and the shear strain when the container is provided in the form of a PP fixture will be described. The most frequently used container in a rheometer that measures rheological properties is a PP fixture, which is provided as shown in FIG. 4A.

In the present invention, regarding the representative shear rate \overline{\dot{γ}} and the representative shear strain γ̅₀ represented by Mathematical Formulas 14 and 15, since the shear rate and the shear strain generally used in the PP fixture of the rheometer are not accurate values, the representative physical quantities need to be corrected. In other words, when the container 20a is provided in a PP shape, the representative shear rate and the representative shear strain of the fluid to be measured may be corrected on the basis of the Metzner-Otto constant (MO constant) as in Mathematical Formulas 24a and 24b below.

As shown in FIG. 4A, the velocity inside a PP fixture-shaped container 20a with a radius R (0.5D) and height H, which rotates at an angular velocity Ω, may be expressed as v(r,z)−rΩz|H, where only the circumferential component is present and the axial coordinate is represented as Z. In addition, the velocity at the end of the PP is v(Rz)−RΩz|H, the shear rate is \overline{\dot{γ}}−rΩ|H, and the shear rate at the end of the PP is \overline{\dot{γ}}_{R}=RΩ|H.

In a conventional rheometer, the average shear rate \overline{\dot{γ}} is the average value of the shear rate inside the PP container 20a, which is the value obtained by integrating the shear rate inside the PP container 20a over the flow volume and dividing it by the volume. In addition, as in Mathematical Formula 20a below, it becomes ⅔ of the shear rate at the end, and when this is integrated over time, the conventionally used shear rate γ_{old} may be expressed as a function of the rotation angle θ of the axis, as in Mathematical Formula 20b below.

$${\overline{\dot{γ}}}_{old} = ( {\int }_{V} \dot{γ} dV ) / V = \frac{2}{3} \frac{RQ}{H} = \frac{2}{3} {\dot{γ}}_{R} \qquad [ Mathematical Formula 20 a ]$$

$${\dot{γ}}_{old} = \frac{2}{3} \frac{R}{H} θ \qquad [ Mathematical Formula 20 b ]$$

By applying Mathematical Formulas 12 and 14, which are methods for obtaining the representative shear rate and shear strain from the above-described rotating body 10 of a general shape, the representative shear rate of the PP-shaped container 20a may be calculated. In addition, the viscosity η of the PP container 20a rotating at the rotational speed and the power applied to a Newtonian fluid may be expressed as in Mathematical Formula 21 below.

$${P}_{Newt} = \int {η ( \frac{\partial v}{\partial z} )}^{2} \qquad [ Mathematical Formula 21 ]$$

$$dV = \frac{πη {R}^{4} {Ω}^{2}}{2 H}$$

In addition, in order to obtain the representative shear rate of a non-Newtonian fluid, the power is calculated using the power series viscosity model (Power-law model) η=K·γⁿ⁺¹, and when this is defined as the power of a non-Newtonian fluid, it may be expressed as in Mathematical Formula 22.

$${P}_{NN} = {\int }_{V} {K ( \frac{rQ}{H} )}^{n + 1} \qquad [ Mathematical Formula 22 ]$$

$$dV = \frac{2 π {KQ}^{n + 1}}{{H}^{n}} \cdot \frac{1}{n + 3} \cdot ( {R}^{n + 3} )$$

When the viscosity is defined so that Mathematical Formulas 21 and 22 are the same, the representative viscosity is defined, and when it is expressed in the form of a power-law viscosity model η=K·γⁿ⁺¹, it can be expressed in a relationship as in Mathematical Formula 23 below.

$$\frac{η = 4 K \cdot {R}^{n - 1} \cdot {Ω}^{n - 1}}{{H}^{n - 1} ( n + 3 )} = K \cdot {( \frac{R \cdot Ω}{H} )}^{n - 1} {( {( \frac{4}{n + 3} )}^{\frac{1}{n - 1}} )}^{n - 1} = K \cdot {( \frac{R \cdot Ω}{H} \cdot {( \frac{4}{n + 3} )}^{\frac{1}{n - 1}} )}^{n - 1} = K \cdot {\overline{\dot{γ}}}^{n - 1} \qquad [ Mathematical Formula 23 ]$$

By comparing Mathematical Formula 23 with the power series viscosity model, the representative shear rate \overline{\dot{γ}} is obtained as in Mathematical Formulas 24a and 24b below, and when expressed as a constant of the end shear rate \dot{γ}_{R} as in the conventional technology, the Metzner-Otto constant (MO constant)

$${K}_{S}^{PP}$$

of the PP container 20a may be calculated. In other words, the representative shear rate of the PP fixture container corresponds to 0.765 of the shear rate \dot{γ}_{R} as in Mathematical Formula 24a below for the power series viscosity model. In addition, when Mathematical Formula 24a is integrated, the correlation between the rotation angle of the axis and the representative shear rate is as in Mathematical Formula 24b below

$$( \overline{γ} = \frac{{K}_{s}}{2 π} {θ}_{0} = {α}_{γ} {θ}_{0} ) .$$

$$\overline{\dot{γ}} = {( \frac{4}{n + 3} )}^{\frac{1}{n - 1}} \cdot ( \frac{Ω R}{H} ) = {K}_{S}^{PP} \cdot {\dot{γ}}_{R} \approx 0.7 \; 65 {\dot{γ}}_{R} \qquad [ Mathematical Formula 24 a ]$$

$${K}_{S}^{PP} = {\int }_{0}^{1} {( \frac{n + 3}{4} )}^{\frac{1}{1 - n}} dn \approx 0.765$$

$$\overline{γ} = {K}_{S}^{PP} \frac{R}{H} θ \approx 0.765 \frac{R}{H} θ . \qquad [ Mathematical Formula 24 b ]$$

Considering that the value of

$${K}_{S}^{PP}$$

may vary within a small range depending on the commonly used viscosity model and the rotational speed of the rotating body, taking into account the deviation of ±10% of 0.765,

$${K}_{S}^{PP}$$

may be a value between 0.6885 and 0.8415. (In conventional technology,

$${K}_{S}^{PP}$$

is ⅔.)

Hereinafter, it will be described that the shape of the container is improved to provide functionality, as shown in FIGS. 4B, 4C, and 4D.

When the viscoelasticity measurement method of the rotating body 10 flow according to the present invention is applied to the conventional rheological property measurement containers, such as PP fixtures and CP fixtures, the shape of the container 20 may be improved to provide additional functionality, as shown in FIGS. 4A-4D. FIG. 4B shows a PP container 20b whose ends are wrapped by walls, and it is free from edge fracture, thereby increasing the ease of measurement. FIG. 4C shows a container 20c in the form of a container with patterns on all inner walls, which may be applied to the viscoelasticity measurement of high molecular-weight polymers, suspensions with high particle fractions, and the like. In addition to the PP-shaped container 20, the CP-shaped container 20d as shown in FIG. 4D may also be applied in the same manner to improve the shape. Compared to the PP container 20b shown in FIG. 4B, the CP container 20d shown in FIG. 4D allows the material loading process to be conducted more easily. It is obvious that the shape improvement of the existing container 20 is not limited to the embodiment shown in FIGS. 4A-4D, and the shape may be improved in various forms within a scope that does not depart from the present invention.

Hereinafter, the measurement of viscoelasticity of a non-Newtonian fluid using a system and method for measuring viscoelasticity of a fluid using a rotating body of an arbitrary shape according to the present invention, and the theoretical data and predicted data for proving the reliability of the correction of the representative shear strain of a PP sphere-shaped container will be described.

### Experiment 1. Comparison of Linear Viscoelasticity Data of Polyethyleneoxide (PEO) (4 M) 4 Wt % Non-Newtonian Fluid

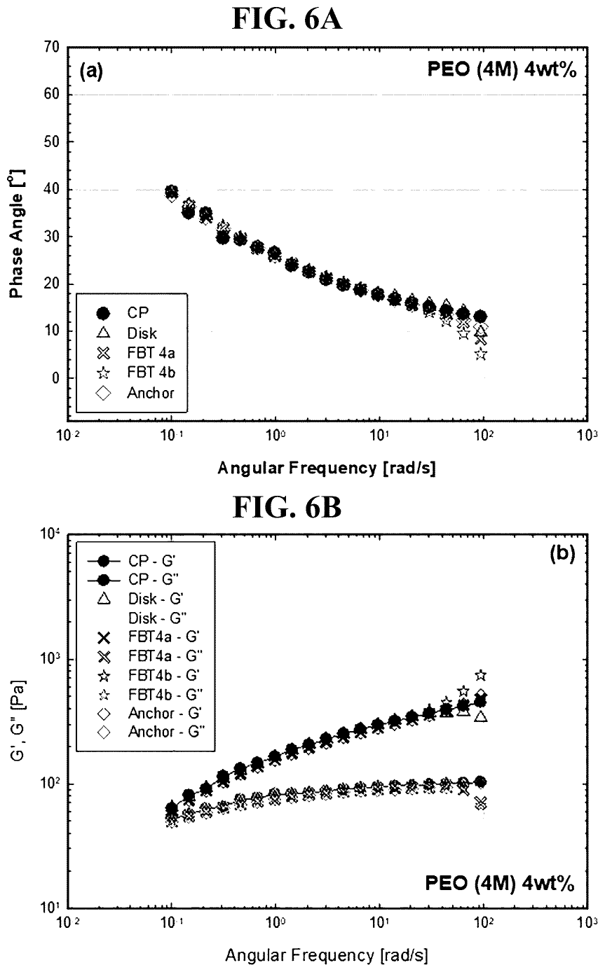

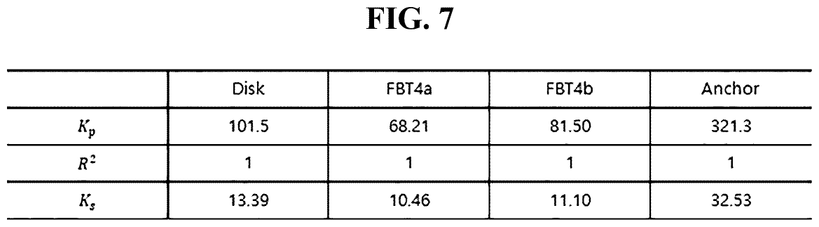

Hereinafter, the linear viscoelasticity data of the CP geometry of a rheometer, which is a device capable of measuring the rheological properties of a material most accurately, is compared with the linear viscoelasticity data of four types of rotating bodies of arbitrarily shapes (Disk, FBT2, FBT3, Anchor) using the system and method for measuring the viscoelasticity of a fluid using rotating body of an arbitrary shape according to the present invention. The Ks and Kp values of the four types of rotating bodies used are presented in FIG. 7, and the linear viscoelasticity data measured using these are presented in FIGS. 6A-6B. FIGS. 6A-6B also present viscoelasticity measurement data using the standard CP fixture. The linear viscoelasticity data obtained in FIGS. 6A-6B are values measured using a rotation angle amplitude of 6.28×10⁻³ [rad].

FIG. 6A shows a graph comparing the phase angle of a non-Newtonian fluid (PEO (4 M) 4 wt %) measured by a rheometer CP and four rotating bodies of arbitrary shapes (Disk, FBT2, FBT3, Anchor) under a linear regime (small amplitude oscillatory shear, SAOS). FIG. 6B shows a graph comparing the storage modulus (G′) and loss modulus (G″) of the four rotating bodies of arbitrary shapes (Disk, FBT2, FBT3, Anchor) reflecting in the phase difference and amplitude of the torque signal when dynamic oscillatory shear is applied, with the rheometer CP. Both graphs in FIGS. 6A-6B show a very high consistency between the experimental values and the predicted values obtained by using the measurement method according to the present invention.

### Experiment 2. Comparison of Nonlinear Viscoelastic Data of PEO (4 M) 4 wt % Non-Newtonian Fluid

Below are the results of comparing the nonlinear viscoelastic data of the CP geometry of a rheometer, which is a device capable of measuring the rheological properties of a material most accurately, with the nonlinear viscoelastic data of four types of rotating bodies of arbitrarily shapes (Disk, FBT2, FBT3, Anchor) using the system and method for measuring the viscoelasticity of a fluid using rotating body of an arbitrary shape according to the present invention. In this experiment, the nonlinear viscoelasticity data (storage modulus, loss modulus) measured with the CP geometry of the non-Newtonian fluid (PEO (4M) 4 wt %), measured under the nonlinear region (large amplitude oscillatory shear, LAOS) corresponding to complex flow and large deformation including the linear region where the internal structure of the material is not broken, are compared with the nonlinear viscoelasticity data values predicted for four types of rotating bodies of arbitrarily shapes (Disk, FBT2, FBT3, Anchor).

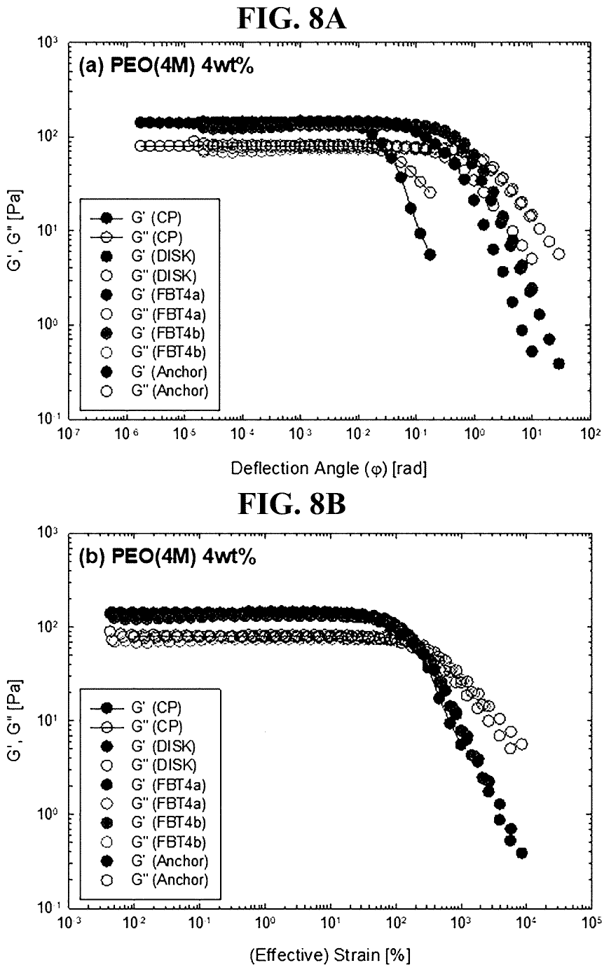

FIGS. 8A-8B show graphs illustrating the results of predicting the linear and nonlinear storage modulus (G′) and loss modulus (G″) of the standard rheometer fixture CP and the rotating bodies of arbitrary shapes (Disk, FBT2, FBT3, Anchor). FIG. 8A shows a graph illustrating the G′ and G″ behavior with respect to the rotation angle of the axis, and FIG. 8B shows a graph of G′ and G″ behavior with respect to the representative strain corrected by Ks. As shown in FIG. 8A, it can be confirmed that the measurement results of the rotating bodies of arbitrary shapes show a significant deviation when compared with the uncorrected data for the given rotation angle, which is the standard rheometer fixture CP. FIG. 8B shows the G′ and G″ with respect to the representative strain corrected for the rotation angle using Mathematical Formula 15, and it can be seen that the results show a very high consistency. The above-described results support the idea that linear and nonlinear viscoelastic data measured under oscillatory shear flow, which was previously considered to be the exclusive domain of expensive, cutting-edge equipment such as rheometers, may be used be predicted very accurately, even when using a rotating body of an arbitrary shape, without a rheometer, by using the rheological property measurement method according to the present invention. In other words, it can be seen that the viscoelastic rheological property information of a fluid can be very accurately predicted even when using a rotating body of an arbitrary shape, and by selecting various shapes of rotating fixtures and containers, problems such as end collapse, difficulty in sample loading, and high-shear region can all be solved.

### Experiment 3. Correction of Representative Shear Rate of PP Fixture

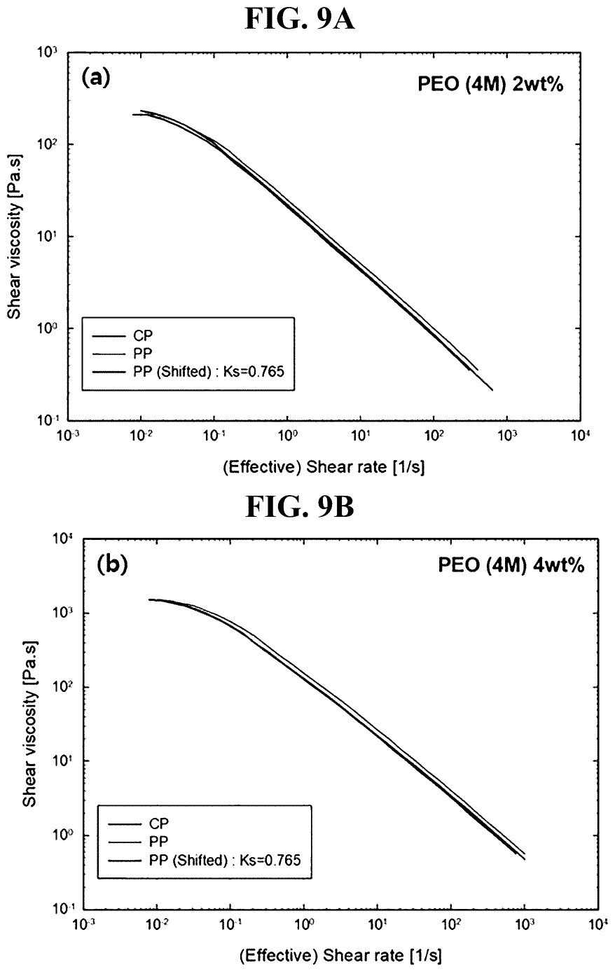

This experiment presents viscosity data and nonlinear viscoelasticity (LAOS) data depending on shear rate for a PP fixture with a gap (H) of 1 mm for a PEO 4 M polymer solution, and the results for a CP fixture are also presented for comparison. Referring to FIGS. 9A-9B, FIGS. 9A and 9B present the representative shear rate presented in the conventional technology Mathematical Formula 20a of the PP fixture for 2 wt % and 4 wt % PEO 4 M polymer aqueous solutions, respectively, when the representative shear rate is calculated by multiplying ⅔ of the end shear rate, and when the representative shear rate is calculated by multiplying the shear rate of the technology by 0.765 as in Mathematical Formula 24a. The values for the CP fixture showing the most accurate values are also presented.

The conventional technique of obtaining the shear rate of a PP fixture and obtaining the viscosity behavior according to the shear rate is not appropriate because it measures a higher viscosity than the case of the PP fixture applying the shear rate using the measuring method according to the present invention and the case of using the CP fixture. In addition, the PP fixture and the CP fixture applying the measuring method according to the present invention show almost the same viscosity and shear rate correlation. In other words, it can be seen through FIGS. 9A and 9B that the shear rate correction through Mathematical Formula 24b was accurate for two different polymer solutions.

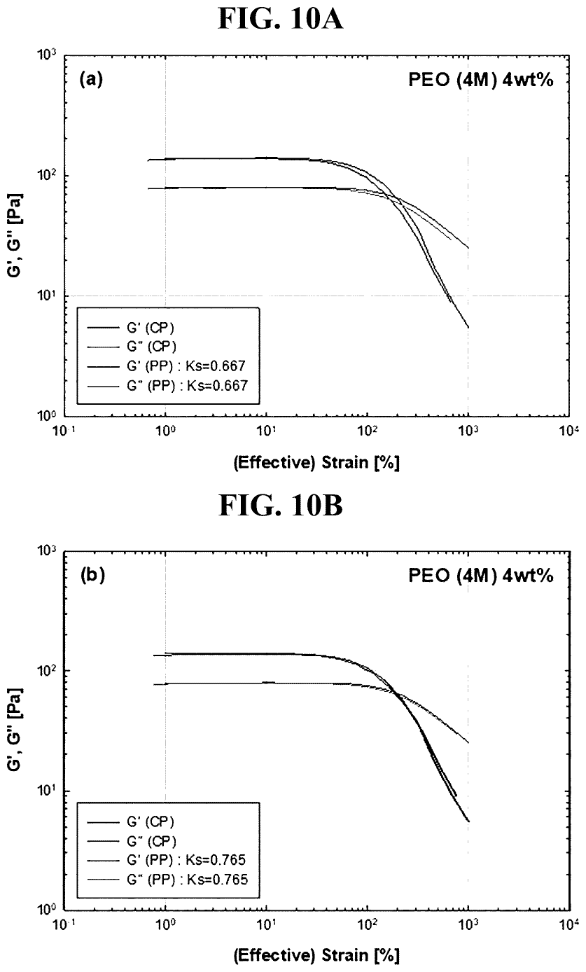

In addition, FIGS. 10A-10B show graphs comparing the nonlinear storage modulus (G′) and loss modulus (G″) measurement results of the CP and PP rheometer standard fixtures. FIG. 10A shows a data graph when a representative shear rate multiplied by ⅔ of the end shear rate was used in a conventional technique, and FIG. 10B shows a data graph when a representative shear rate obtained by the method according to the present invention was used. FIG. 10A shows that when the correction for the rotation angle given in Mathematical Formula 24b was not applied but the conventional ⅔ (=0.667) was applied to the end shear rate in the correlation between the rotation angle and shear rate used in the PP fixture and when the data was compared with the CP fixture, which is a rheometer standard fixture, there was a significant difference in G′ and G″. FIG. 10B shows the data obtained by applying the shear rate obtained by introducing a correction for the rotation angle given in Mathematical Formula 24b to the data of the PP fixture, indicating a high consistency in G′ and G″ compared to the standard fixture CP.

As such, it will be understood by those skilled in the art that the above-described technical configuration of the present invention can be implemented in other specific forms without altering the technical spirit or essential characteristics of the present invention.

Therefore, the above-described embodiments should be understood as illustrative and not restrictive in all respects, and the scope of the present invention is indicated by the claims described below rather than the detailed description above, and all changes or modifications derived from the meaning and scope of the claims and their equivalent concepts should be interpreted as being included within the scope of the present invention.

### REFERENCE NUMERALS

10: Rotating body
11: Rotating axis
12: Paddle
20: Container
30: Measurement portion
40: Monitoring module
41: Receiving portion
42: Output portion
43: Monitoring portion

1. A system for measuring rheological properties of a fluid using a rotating body of an arbitrary shape, the system comprising:
a container capable of containing a fluid;
a rotating body that is arranged vertically from the ground and moves under preset conditions while inserted into the container in contact with the fluid;
a measurement portion measuring motion information of the rotating body; and
a monitoring module displaying rheological property information of the fluid on the basis of the motion information of the rotating body measured by the measuring portion,
wherein the monitoring module is capable of calculating rheological property information of the fluid regardless of shapes of the rotating body and the container.

2. The system of claim 1, wherein the monitoring module inputs the motion information measured from the measuring portion into [Mathematical Formula 9] below to display the rheological property information of the fluid:
$${G}^{′} ( ω ) = ω {η}^{′′} ( ω ) = \frac{1}{α} \frac{{M}_{0}}{{θ}_{0}} cos δ , \qquad [ Mathematical Formula 9 ]$$
$${G}^{′′} ( ω ) = ω {η}^{′} ( ω ) = \frac{1}{α} \frac{{M}_{0}}{{θ}_{0}} sin δ .$$

3. The system of claim 1, wherein the rotating body includes a paddle provided at an end of the rotating body, and the paddle is provided to be point-symmetrical with respect to a cross-section in an axial direction of the rotating body, so that no bending moment is applied to an axis of the rotating body when stationary, and a drag force due to the fluid is applied uniformly even when rotating.

4. A method for measuring rheological properties of a fluid using a rotating body of an arbitrary shape using the rheological property measurement system of claim 1, the method comprising:
a shape coefficient derivation step of deriving a shape coefficient of the rotating body on the basis of the motion characteristics of the rotating body for a fluid of which rheological properties are known;
a motion measurement step in which a measurement portion measures motion information of the rotating body moving under preset conditions while the rotating body is in contact with the fluid of which rheological properties are to be measured in a container; and
a rheological property calculation step of calculating rheological property information of the fluid to be measured on the basis of the shape coefficient of the rotating body and the motion information of the rotating body.

5. The method of claim 4, wherein the rheological property calculation step substitutes the motion information into [Mathematical Formula 9] below and calculates the rheological property information of the fluid to be measured, by the monitoring module:
$${G}^{′} ( ω ) = ω {η}^{′′} ( ω ) = \frac{1}{α} \frac{{M}_{0}}{{θ}_{0}} cos δ , \qquad [ Mathematical Formula 9 ]$$
$${G}^{′′} ( ω ) = ω {η}^{′} ( ω ) = \frac{1}{α} \frac{{M}_{0}}{{θ}_{0}} sin δ .$$

6. The system of claim 4, wherein, when the fluid to be measured is a non-Newtonian fluid, the shape coefficient of the rotating body is calculated from a proportional constant of dimensionless Power number Nₚ and Reynolds number Re, as in [Mathematical Formula 12] below:
$$M = \frac{2 {R}^{3}}{{π}^{2}} {K}_{p} \cdot ηΩ = α ηΩ , \qquad [ Mathematical Formula 12 ]$$
$$α = \frac{2 {R}^{3}}{{π}^{2}} {K}_{p} .$$

7. The system of claim 4, wherein, the rheological property calculation step calculates a representative shear rate through [Mathematical Formula 14] below, a representative shear strain through [Mathematical Formula 15] below, and a representative shear stress through [Mathematical Formula 17] below:
$$\overline{\dot{γ}} = {K}_{s} N = \frac{{K}_{s}}{2 π} Ω \qquad [ Mathematical Formula 14 ]$$
$${\overline{γ}}_{0} = \frac{{K}_{s}}{2 π} {θ}_{0} = {α}_{γ} {θ}_{0} \qquad [ Mathematical Formula 15 ]$$
$${α}_{γ} = \frac{{K}_{s}}{2 π}$$
$$\overline{τ} = η \overline{\dot{γ}} = \frac{π}{4 {R}^{3}} \frac{{K}_{s}}{{K}_{p}} \cdot M = {α}_{τ} M , \qquad [ Mathematical Formula 17 ]$$
$${α}_{τ} = \frac{π}{4 {R}^{3}} \frac{{K}_{s}}{{K}_{p}} .$$

8. The system of claim 4, wherein, when the container is provided in a parallel plate (PP) shape, the representative shear rate and the representative shear strain of the fluid to be measured are corrected based on the Metzner-Otto constant (MO constant), as shown in [Mathematical Formula 24a] and [Mathematical Equation 24b] below:
$$\overline{\dot{γ}} = {( \frac{4}{n + 3} )}^{\frac{1}{n - 1}} \cdot ( \frac{Ω R}{H} ) = {K}_{S}^{PP} \cdot {\dot{γ}}_{R} \approx 0.7 \; 65 {\dot{γ}}_{R} \qquad [ Mathematical Equation 24 a ]$$
$${K}_{S}^{PP} = {\int }_{0}^{1} {( \frac{n + 3}{4} )}^{\frac{1}{1 - n}} dn \approx 0.765$$
$$\overline{γ} = {K}_{S}^{PP} \frac{R}{H} θ \approx 0.765 \frac{R}{H} θ . \qquad [ Mathematical Equation 24 b ]$$
